(19) United States
(12) Patent Application Publication
(10) Pub. No.: US 2010/0041835 A1
(43) Pub. Date: Feb. 18, 2010

(54) POLYESTER MIXTURE COMPRISING BIODIESEL

(75) Inventors: Dietrich Scherzer, Neustadt (DE); Motonori Yamamoto, Mannheim (DE); Gabriel Skupin, Speyer (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE Patents, Trademarks and Lincense, Ludwigshafen (DE)

(21) Appl. No.: 12/529,032

(22) PCT Filed: Feb. 26, 2008
(86) PCT No.: PCT/EP08/52279

§ 371 Date: Aug. 28, 2009

(30) Foreign Application Priority Data
Mar. 1, 2007 (EP) 07103323.7

(51) Int. Cl. C08G 63/91; C08G 63/08

(52) U.S. Cl. 525/410; 525/450; 525/418

(57) ABSTRACT

The present invention relates to biodegradable polyester mixtures, comprising
i) from 95 to 99.95% by weight, based on the total weight of components i to ii, of at least one biodegradable homo- or copolyester selected from the following group: polylactide, polycaprolactone, polyhydroxyalkanoate, and polyester composed of aliphatic or aliphatic and aromatic dicarboxylic acids and of aliphatic dihydroxy compounds, and
ii) from 0.05 to 5% by weight, based on the total weight of components i to ii, of biodiesel.

The present invention also relates to processes for the production of the polyester mixtures of the invention, to the use of the polyester mixtures of the invention for the production of moldings, foils, or fibers, and also to moldings, foils, or fibers comprising the polyester mixtures of the invention.

The present invention relates to biodegradable polyester mixtures, comprising
i) from 95 to 99.95% by weight, based on the total weight of components i to ii, of at least one biodegradable homo- or copolyester selected from the following group: polylactide, polycaprolactone, polyhydroxyalkanoate, and polyester composed of aliphatic or aliphatic and aromatic dicarboxylic acids and of aliphatic dihydroxy compounds, and
ii) from 0.05 to 5% by weight, based on the total weight of components i to ii, of biodiesel.

The present invention also relates to processes for the production of the polyester mixtures of the invention, to the use of the polyester mixtures of the invention for the production of moldings, foils, or fibers, and also to moldings, foils, or fibers comprising the polyester mixtures of the invention.

Biodegradable polyesters i, or polyester mixtures composed of ia) polyesters, composed of aliphatic or aliphatic and aromatic dicarboxylic acids and of aliphatic diols, and/or polylactide, and ib) polyhydroxybutyrates are known (see EP-B 792 309). Mixtures of this type provide an ideal combination of the desirable properties of the individual components, for example the generally good processing properties and mechanical properties of the synthetic polyesters ia with the usually lower-cost availability and environmentally compatible production and disposal of the polyhydroxybutyrates ib.

In practice, the property profile of the known polyesters i and mixtures ia/ib is not always entirely satisfactory. Most biopolymers, such as polylactide and polyhydroxyalkanoates, are sticky, high-viscosity materials, and their processing therefore requires high energy input. A direct result of this is molecular-weight degradation of the biopolymers, which are to some extent heat-sensitive. When foils are produced, production stoppages also occur because of sticking to the rolls. In particular, it is impossible to use this process for cost-effective production of the thin foils which are conventional in the packaging industry.

It is therefore an object of the present invention to provide biodegradable polyester mixtures which do not have the abovementioned disadvantages.

This object is achieved using the biodegradable polyester mixtures defined in the introduction, and these are described in more detail below. The polyester mixtures of the invention differ from those of the prior art in the addition of biodiesel (component ii). Biodiesel in the polyesters i exhibits an excellent lubricant action, even superior to the action of conventional lubricants, such as calcium stearate and erucamide. The viscosity of the polymer mixtures is moreover reduced and the sticking effect is mitigated. Table 1 compares the properties of the mixtures of the invention with those of the prior art.

Biodiesel means esters, in particular methyl esters, of fatty acids and of vegetable oils. An example of biodiesel is methylated rapeseed oil. However, biodiesel can also be produced from other vegetable oils, such as soybean oil, sunflower oil, and palm oil. The production of biodiesel is described by way of example in Chemie Ingenieur Technik (75), pages 787 to 791, and in Bioresource Technology 70 (1999), pages 1 to 15.

The polyester mixtures of the invention comprise from 0.05 to 5% by weight, preferably from 0.1 to 2% by weight, and with particular preference from 0.1 to 1% by weight, of biodiesel, based on components i and ii.

According to the invention, the term semiaromatic polyesters is also intended to include polyester derivatives, such as polyetheresters, polyesteramides, or polyetherester-amides. Among the suitable semiaromatic polyesters are linear non-chain-extended polyesters (WO 92/09654). Preference is given to chain-extended and/or branched semiaromatic polyesters. The latter are known from the specifications mentioned in the introduction, WO 96/15173 to 15176, WO 96/21689 to 21692, WO 96/25446, WO 96/25448, or WO 98/12242, which are expressly incorporated herein by way of reference. Mixtures of various semiaromatic polyesters can likewise be used. The term semiaromatic polyesters in particular means products such as Ecoflex® (BASF Aktiengesellschaft) and Eastar® Bio (Novamont).

Among the particularly preferred semiaromatic polyesters are polyesters which comprise, as essential components,
A) an acid component composed of
   a1) from 30 to 99 mol % of at least one aliphatic, or at least one cycloaliphatic, dicarboxylic acid, or its ester-forming derivatives, or a mixture of these,
   a2) from 1 to 70 mol % of at least one aromatic dicarboxylic acid, or its ester-forming derivative, or a mixture of these, and
   a3) from 0 to 5 mol % of a compound comprising sulfonate groups,
B) a diol component selected from at least one C2-C12 alkanediol or from at least one C5-C10 cycloalkanediol, or a mixture of these,
   and, if desired, also one or more components selected from
C) a component selected from
   c1) at least one dihydroxy compound comprising ether functions and having the formula I

HO—[(CH₂)ₙ—O]ₘ—H (I)
where n is 2, 3 or 4 and m is a whole number from 2 to 250,
c2) at least one hydroxycarboxylic acid of the formula IIa or IIb

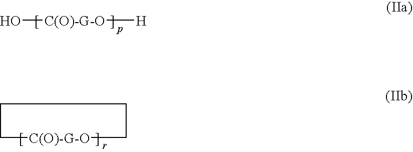

where p is a whole number from 1 to 1500 and r is a whole number from 1 to 4, and G is a radical selected from the group consisting of phenylene, —(CH2)q-, where q is a whole number from 1 to 5, —C(R)H—, and —C(R)HCH2, where R is methyl or ethyl,
c3) at least one amino-C2-C12 alkanol, or at least one amino-C5-C10 cycloalkanol, or a mixture of these,
c4) at least one diamino-C1-C8 alkane,
c5) at least one 2,2′-bisoxazoline of the general formula III

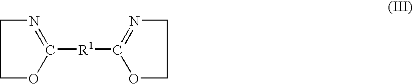

where R1 is a single bond, a (CH2)z-alkylene group, where z=2, 3 or 4, or a phenylene group, and
c6) at least one aminocarboxylic acid selected from the group consisting of the naturally occurring amino acids, polyamides obtainable by polycondensing a dicarboxylic acid having from 4 to 6 carbon atoms with a diamine having from 4 to 10 carbon atoms, compounds of the formulae IVa and IVb

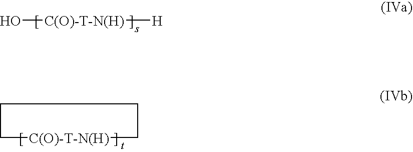

where s is a whole number from 1 to 1500 and t is a whole number from 1 to 4, and T is a radical selected from the group consisting of phenylene, —(CH2)u-, where u is a whole number from 1 to 12, —C(R2)H—, and —C(R2)HCH2-, where R2 is methyl or ethyl,
and polyoxazolines having the repeat unit V

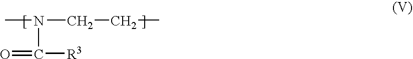

where R3 is hydrogen, C1-C6-alkyl, C5-C8-cycloalkyl, phenyl, either unsubstituted or with up to three C1-C4-alkyl substituents, or tetrahydrofuryl,
or a mixture composed of c1 to c6,
and
D) a component selected from
   d1) at least one compound having at least three groups capable of ester formation,
   d2) at least one isocyanate, and
   d3) at least one divinyl ether,
   or a mixture composed of d1) to d3).

The component a1 used preferably comprises succinic acid, adipic acid, azelaic acid, sebacic acid, brassylic acid, or the respective ester-forming derivatives thereof, or a mixture of these. It is particularly preferable to use succinic acid, adipic acid, or sebacic acid, or the respective ester-forming derivatives thereof, or a mixture of these. It is particularly preferable to use adipic acid or ester-forming derivatives thereof, e.g. the alkyl ester thereof, or a mixture of these. When polymer mixtures having “hard” or “brittle” components ib, for example polyhydroxybutyrate, are produced, it is preferable that the aliphatic dicarboxylic acid used comprises sebacic acid or a mixture of sebacic acid with adipic acid. When polymer mixtures having “soft” or “tough” components ib, for example polyhydroxybutyrate-co-valerate, are produced, it is preferable that the aliphatic dicarboxylic acid used comprises succinic acid or a mixture of succinic acid with adipic acid.

Succinic acid, azelaic acid, sebacic acid, and brassylic acid also have the advantage that they are available as renewable raw materials.

The aromatic dicarboxylic acids or ester-forming derivatives of these a2 can be used individually or in the form of a mixture composed of two or more of these. It is particularly preferable to use terephthalic acid or ester-forming derivatives thereof, e.g. dimethyl terephthalate.

The semiaromatic polyesters mentioned, and the polyester mixtures of the invention, are generally biodegradable.

For the purposes of the present invention, compliance with the feature “biodegradable” for a substance or a substance mixture means that said substance or the substance mixture has a percentage degree of biodegradation of at least 60% in at least one of the three methods defined in DIN V 54900-2 (preliminary standard, as at September 1998).

Alongside the polyesters described above, composed of aliphatic dicarboxylic acids and of aliphatic diols, and, respectively, of semiaromatic dicarboxylic acids, the following biopolymers are suitable as component i: polylactide, polycaprolactone, polyhydroxyalkanoates. Preferred components ii are polylactide (PLA) and polyhydroxyalkanoates, and in particular here polyhydroxybutyrate (PHB), and polyhydroxybutyrate-co-valerate (PHBV). Particular products comprised are those such as NatureWorks® (polylactide from Cargill Dow), Biocycle® (polyhydroxybutyrate from PHB Ind.); Enmat® (polyhydroxybutyrate-co-valerate from Tianan).

One preferred embodiment of the present invention relates to polyester mixtures according to claim 1 where component i is composed of the following:
ia) from 90 to 99.9% by weight, based on components i, of a polylactide or of a polyester composed of aliphatic or aliphatic and aromatic dicarboxylic acids and of aliphatic dihydroxy compounds, and
ib) from 0.1 to 10% by weight, based on components i, of a polyhydroxybutyrate.

An unattractive property of biodiesel is that it can migrate to the surface of, for example, a foil. The final result of this can be what is known as biodiesel exudation, and reduced lubricant effect.

Surprisingly, it has now been found that the addition of polyhydroxybutyrates, such as Enmat® from Tianan or Biocycle® from PHB Industrials can suppress or entirely eliminate the exudation of the biodiesel.

It is generally sufficient to add from 0.1 to 20% by weight, preferably from 0.1 to 10% by weight, and particularly preferably from 0.1 to 5% by weight, of the polyhydroxybutyrate—based on component i. The lubricant effect of the biodiesel can thus be markedly amplified.

For the production of extruded thermoplastics, for example foils, bubble stability is of great importance. It has now been found that mixtures in which component ia forms a preferably continuous phase or at least a cocontinuous phase, and component ib has been embedded in separate regions into said phase have good bubble stability. The mixtures generally have more than 40% by weight of component ia, in order that component ia forms a continuous phase.

The biodegradable polyester mixtures of the invention can comprise further ingredients which are known to the person skilled in the art but which are not essential to the invention. By way of example, the additives conventional in plastics technology, e.g. stabilizers, neutralizing agents, lubricants and release agents, antiblocking agents, dyes, or fillers.

The polyester mixtures can comprise compatibilizers in addition to the conventional additives, examples being a copolymer containing epoxide groups and based on styrene, acrylate, and/or methacrylate, or on a bisphenol A epoxide, or on a natural oil containing epoxide groups, or a fatty acid ester or fatty acid amide, as component iii.

It is preferable to use a copolymer containing epoxide groups and based on styrene, acrylate, and/or methacrylate. The compounds generally have two or more epoxide groups in the molecule. Particularly suitable materials are oligomeric or polymeric epoxidized compounds, such as di- or polyglycidic esters of di- or polycarboxylic acids, or di- or polyglycidic ethers of di- or polyols, or copolymers composed of styrene and of glycidyl(meth)acrylates, for example those marketed by Johnson Polymer with the trademark Joncryl® ADR 4368.

Other preferred components iii are compounds which comprise at least one carbon-carbon double bond or carbon-carbon triple bond, and at least one epoxide group in the molecule. Particularly suitable materials are glycidyl-acrylate-containing and glycidyl-methacrylate-containing polymers.

The amount of component iii) used, based on the total weight of components i) to ii), is from 0.1 to 15% by weight, preferably from 0.1 to 10% by weight, and particularly preferably from 0.5 to 2% by weight.

Known processes can be used to produce the biodegradable polyester mixtures of the invention from the individual components (EP 792 309 and U.S. Pat. No. 5,883,199).

By way of example, one step of a process can be used for mixing and reaction of all of the components ia, ib, and ii, in mixing apparatuses known to the person skilled in the art, examples being kneaders or extruders, at elevated temperatures, for example from 120° C. to 200° C.

An improved process for production of the preferred polyester mixtures has moreover been found.

For this, in a first step, from 20 to 55% by Weight of component ia is mixed with from 20 to 55% by weight of component ib, and from 15 to 25% by weight of component ii, to give a masterbatch, at temperatures in the range from 110 to 145° C., and, in a second step, component ia and, respectively, ib is admixed with said masterbatch, and the resultant mixture composed of components ia, ib, and iii is reacted at temperatures of from 130 to 200° C.

Use of an activator selected from the group consisting of: zinc, tin, titanium compound, and C1-C12-alkyltriphenylphosphonium halide can generally reduce the temperatures in the compounding step, and thus avoid decomposition of unstable biopolymers, such as polyhydroxybutyrates.

The polyester mixtures of the invention are particularly suitable for production of moldings, foils, or fibers. The production process can use the methods known to the person skilled in the art.

One particular application sector for the biodegradable polyester mixtures with improved degradation rates relates to the use for production of foils, in particular mulch foils for agriculture. These mulch foils are aid on agricultural areas in order to protect, mostly young, seedlings and to accelerate their growth. After harvest, these mulch foils are left on the agricultural area or—in the case of biodegradable mulch foils—ploughed into the soil. Substantial biodegradation of these mulch foils has to take place before the next year's sowing cycle begins.

The biodegradable polyester mixtures of the invention give biodegradable polymer mixtures which can be processed without difficulty (with stable bubble) to give puncture-resistant foils.

### EXAMPLES

### Starting Materials

Component ia): Ecoflex® F BX 7011 (BASF Aktiengesellschaft) NatureWorks® 4042 D (NatureWorks)
Component ib): Biocycle® PHB 94 (PHB Industrial S.A. Inc.)
Component ii) Biodiesel (ADM)

### I. Branching Agent Masterbatches

IE1: 32% Ecoflex, 20% biodiesel, 48% PHB
IE2: 50% Ecoflex, 20% biodiesel, 30% PHB
IE3: 32% Ecoflex, 20% biodiesel, 48% PLA
IE4: 32% Ecoflex, 20% biodiesel, 48% polycaprolactone
IE5: 80% Ecoflex, 20% biodiesel
CE6: 80% Ecoflex, 20% erucamide
CE7: 80% Ecoflex, 20% calcium stearate

### II: Production of Molding Compositions and Foil Production:

The molding compositions were used in the mixing ratios stated in Table 1 to produce foils by the chill-roll extrusion process, on a chill-roll plant from Reifenhäuser, using an extruder diameter of 90 mm, an extruder length of 2250 mm, and two chill rolls (diameter of first roll: 400 mm; diameter of second roll: 150 mm), at a melt temperature of 175° C., a throughput of 38 kg/h, a draw steed of 15 m/min, and the roll temperature stated in Table 1 for the chill rolls, all of the other conditions being in each case identical. Table 1 shows the frequency of sticking of the molding compositions to the chill rolls during foil production. Sticking was discernible in that the foil began to stick to the first rotating roll beyond the usual release point, this then being followed by sudden release (whereas a non-sticking foil always released at the same release point from the first rotating roll, without any sudden movements). The sticking frequency shown in the final column of Table 1 is the number, per minute, of visually discernible sudden release movements of the foil from the first rotating roll.

TABLE 1

| | | Amount of | | |
|---|---|---|---|---|
| | Amount of | branching | Roll | Sticking |
| | Ecoflex ® in | masterbatch in | temperature | frequency per |
| Examples | % by weight | % by weight | (° C.) | min. |
| C1* | 100 | — | 50 | 60 |
| C2* | 100 | — | 70 | >60 |
| 3 | 99.5 | IE1, 0.5% | 50 | 0 |
| 4 | 99.5 | IE1, 0.5% | 70 | 5 |
| 5 | 99.5 | IE2, 0.5% | 50 | 0 |
| 6 | 99.5 | IE2, 0.5% | 70 | 7 |
| 7 | 99.5 | IE3, 0.5% | 50 | 10 |
| 8 | 99.5 | IE3, 0.5% | 70 | 22 |
| 9 | 99.5 | IE4, 0.5% | 50 | 11 |
| 10 | 99.5 | IE4, 0.5% | 70 | 25 |
| 11 | 99.5 | IE5, 0.5% | 50 | 13 |
| 12 | 99.5 | IE5, 0.5% | 70 | 29 |
| C13* | 99.5 | CE6, 0.5% | 50 | 18 |
| C14* | 99.5 | CE6, 0.5% | 70 | 30 |
| C15* | 99.5 | CE7, 0.5% | 50 | 21 |
| C16* | 99.5 | CE7, 0.5% | 70 | 35 |

*Comparative examples, not according to the invention

The foils produced from the molding compositions 3 to 12 of the invention exhibited reduced tendency toward sticking to the tooling during processing, thus permitting increased processing throughput in comparison with the foils produced from molding compositions 1, 2, and 13 to 16.

The foils produced from the preferred polyester mixtures 1 to 6 exhibited a particularly low level of tendency toward sticking. Branching-agent masterbatches IE1 or IE2 were used in these inventive examples.

1. A polyester mixture, comprising
i) from 95 to 99.95% by weight, based on the total weight of components i to ii, of at least one biodegradable homo- or copolyester selected from the following group: polylactide, polycaprolactone, polyhydroxyalkanoate, and polyester composed of aliphatic or aliphatic and aromatic dicarboxylic acids and of aliphatic dihydroxy compounds, and
ii) from 0.05 to 5% by weight, based on the total weight of components i to ii, of biodiesel.

2. The polyester mixture according to claim 1, comprising a component i whose composition is as follows:
ia) from 90 to 99.9% by weight, based on components i, of a polylactide and/or of a polyester composed of aliphatic or aliphatic and aromatic dicarboxylic acids and of aliphatic dihydroxy compounds, and
ib) from 0.1 to 10% by weight, based on components i, of a polyhydroxybutyrate.

3. The polyester mixture according to claim 1, where component ia is composed of the following:
A) an acid component composed of
a1) from 30 to 99 mol % of at least one aliphatic, or at least one cycloaliphatic, dicarboxylic acid, or its ester-forming derivatives, or a mixture of these,
a2) from 1 to 70 mol % of at least one aromatic dicarboxylic acid, or its ester-forming derivative, or a mixture of these, and
a3) from 0 to 5 mol % of a compound comprising sulfonate groups,
where the sum of the molar percentages of components a1) to a3) is 100% and
B) a diol component selected from at least one C2-C12 alkanediol or from at least one C5-C10 cycloalkanediol, or a mixture of these,
and, if desired, also one or more components selected from
C) a component selected from
c1) at least one dihydroxy compound comprising ether functions and having the formula I
HO—[(CH₂)ₙ—O]ₘ—H (I)
where n is 2, 3 or 4 and m is a whole number from 2 to 250,
c2) at least one hydroxycarboxylic acid of the formula IIa or IIb 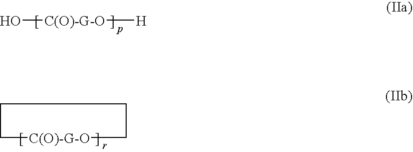
where p is a whole number from 1 to 1500 and r is a whole number from 1 to 4, and G is a radical selected from the group consisting of phenylene, —(CH2)q-, where q is a whole number from 1 to 5, —C(R)H—, and —C(R)HCH2, where R is methyl or ethyl,
c3) at least one amino-C2-C12 alkanol, or at least one amino-C5-C10 cycloalkanol, or a mixture of these,
c4) at least one diamino-C1-C8 alkane,
c5) at least one 2,2′-bisoxazoline of the general formula III 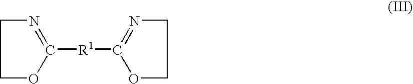
where R1 is a single bond, a (CH2)z-alkylene group, where z=2, 3 or 4, or a phenylene group, and
c6) at least one aminocarboxylic acid selected from the group consisting of the naturally occurring amino acids, polyamides obtainable by polycondensing a dicarboxylic acid having from 4 to 6 carbon atoms with a diamine having from 4 to 10 carbon atoms, compounds of the formulae IVa and IVb 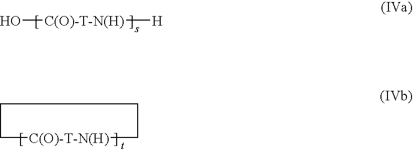
where s is a whole number from 1 to 1500 and t is a whole number from 1 to 4, and T is a radical selected from the group consisting of phenylene, —(CH2)u-, where u is a whole number from 1 to 12, —C(R2)H—, and —C(R2)HCH2-, where R2 is methyl or ethyl,
and polyoxazolines having the repeat unit V 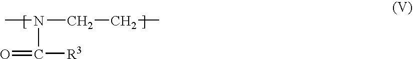
where R3 is hydrogen, C1-C6-alkyl, C5-C8-cycloalkyl, phenyl, either unsubstituted or with up to three C1-C4-alkyl substituents, or tetrahydro furyl,
or a mixture composed of c1) to c6),
and
D) a component selected from
d1) at least one compound having at least three groups capable of ester formation,
d2) at least one isocyanate, and
d3) at least one divinyl ether,
or a mixture composed of d1) to d3).

4. The polyester mixture according to claim 3, where, in component ia:
the aliphatic or cycloaliphatic dicarboxylic acid (component a1)) is succinic acid, adipic acid, or sebacic acid, ester-forming derivatives thereof, or a mixture of these;
the aromatic dicarboxylic acid (component a2)) is terephthalic acid or ester-forming derivatives thereof, and
the diol component (component B) is 1,4-butanediol or 1,3-propanediol.

5. The polyester mixture according to claim 1, where a component iii is also used, being a copolymer which contains epoxide groups and which is based on styrene, acrylate, and/or methacrylate.

6. A biodegradable polyester mixture according to claim 3, where component ia forms a continuous or cocontinuous phase.

7. A process for the production of biodegradable polyester mixtures according to claim 1, which comprises, in one step, mixing components i, ii, and, if appropriate, iii, and reacting them.

8. A process for the production of biodegradable polyester mixtures according to claim 2, which comprises, in a first step, mixing from 20 to 55% by weight of component ia with from 20 to 55% by weight of component ib and from 15 to 25% by weight of component ii to give a masterbatch, at temperatures in the range from 110 to 145° C., and, in a second step, admixing component ia and, respectively, ib with said masterbatch and reacting the resultant mixture composed of components i, ii, and iii, at temperatures of from 130 to 200° C.

9. A branching-agent masterbatch, comprising
a) from 25 to 55% by weight of component ia, defined as in claims 2 to 4, and
b) from 25 to 55% by weight of component ib, defined as in any of claims 2 to 4, and
c) from 15 to 25% by weight of component ii, defined as in claim 1.

10. The use of the biodegradable polyester mixtures according to claim 1 for the production of moldings, foils, or fibers.

11. The polyester mixture according to claim 2, where component ia is composed of the following:
A) an acid component composed of
a1) from 30 to 99 mol % of at least one aliphatic, or at least one cycloaliphatic, dicarboxylic acid, or its ester-forming derivatives, or a mixture of these,
a2) from 1 to 70 mol % of at least one aromatic dicarboxylic acid, or its ester-forming derivative, or a mixture of these, and
a3) from 0 to 5 mol % of a compound comprising sulfonate groups,
where the sum of the molar percentages of components a1) to a3) is 100% and
B) a diol component selected from at least one C2-C12 alkanediol or from at least one C5-C10 cycloalkanediol, or a mixture of these,
and, if desired, also one or more components selected from
C) a component selected from
c1) at least one dihydroxy compound comprising ether functions and having the formula I
HO—[(CH₂)ₙ—O]ₘ—H (I)
where n is 2, 3 or 4 and m is a whole number from 2 to 250,
c2) at least one hydroxycarboxylic acid of the formula IIa or IIb 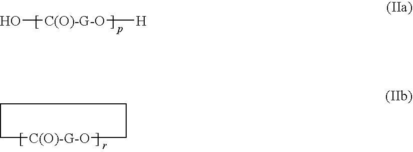
where p is a whole number from 1 to 1500 and r is a whole number from 1 to 4, and G is a radical selected from the group consisting of phenylene, —(CH2)q-, where q is a whole number from 1 to 5, —C(R)H—, and —C(R)HCH2, where R is methyl or ethyl,
c3) at least one amino-C2-C12 alkanol, or at least one amino-C5-C10 cycloalkanol, or a mixture of these,
c4) at least one diamino-C1-C8 alkane,
c5) at least one 2,2′-bisoxazoline of the general formula III 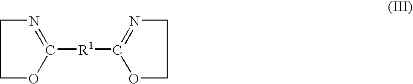
where R1 is a single bond, a (CH2)z-alkylene group, where z=2, 3 or 4, or a phenylene group, and
c6) at least one aminocarboxylic acid selected from the group consisting of the naturally occurring amino acids, polyamides obtainable by polycondensing a dicarboxylic acid having from 4 to 6 carbon atoms with a diamine having from 4 to 10 carbon atoms, compounds of the formulae IVa and IVb 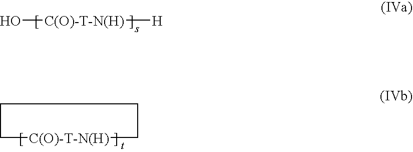
where s is a whole number from 1 to 1500 and t is a whole number from 1 to 4, and T is a radical selected from the group consisting of phenylene, —(CH2)u-, where u is a whole number from 1 to 12, —C(R2)H—, and —C(R2)HCH2-, where R2 is methyl or ethyl,
and polyoxazolines having the repeat unit V 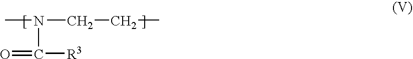
where R3 is hydrogen, C1-C6-alkyl, C5-C8-cycloalkyl, phenyl, either unsubstituted or with up to three C1-C4-alkyl substituents, or tetrahydro furyl,
or a mixture composed of c1) to c6),
and
D) a component selected from
d1) at least one compound having at least three groups capable of ester formation,
d2) at least one isocyanate, and
d3) at least one divinyl ether,
or a mixture composed of d1) to d3).

12. The polyester mixture according to claim 2, where a component iii is also used, being a copolymer which contains epoxide groups and which is based on styrene, acrylate, and/or methacrylate.

13. The polyester mixture according to claim 3, where a component iii is also used, being a copolymer which contains epoxide groups and which is based on styrene, acrylate, and/or methacrylate.

14. The polyester mixture according to claim 4, where a component iii is also used, being a copolymer which contains epoxide groups and which is based on styrene, acrylate, and/or methacrylate.

15. The process for the production of biodegradable polyester mixtures according to claim 2, which comprises, in one step, mixing components i, ii, and, if appropriate, iii, and reacting them.

16. The process for the production of biodegradable polyester mixtures according to claim 3, which comprises, in one step, mixing components i, ii, and, if appropriate, iii, and reacting them.

17. The process for the production of biodegradable polyester mixtures according to claim 4, which comprises, in one step, mixing components i, ii, and, if appropriate, iii, and reacting them.

18. The process for the production of biodegradable polyester mixtures according to claim 5, which comprises, in one step, mixing components i, ii, and, if appropriate, iii, and reacting them.

19. The process for the production of biodegradable polyester mixtures according to claim 6, which comprises, in one step, mixing components i, ii, and, if appropriate, iii, and reacting them.

20. The process for the production of biodegradable polyester mixtures according to claim 3, which comprises, in a first step, mixing from 20 to 55% by weight of component ia with from 20 to 55% by weight of component ib and from 15 to 25% by weight of component ii to give a masterbatch, at temperatures in the range from 110 to 145° C., and, in a second step, admixing component ia and, respectively, ib with said masterbatch and reacting the resultant mixture composed of components i, ii, and iii, at temperatures of from 130 to 200° C.
